(19) United States
(12) Patent Application Publication
(10) Pub. No.: US 2010/0028596 A1
(43) Pub. Date: Feb. 4, 2010

(54) DEVICE FOR GLUING A TAIL CANT OF A ROLL AND PRODUCT ROLL

(75) Inventors: Dirk Mauler, Ilvesheim (DE); Heiko Steuer, Mannheim (DE); Thomas Jankowski, Mannheim (DE); Eric Roth, Mannheim (DE); Ernst Auner, Ludwigshafen (DE)

Correspondence Address: YOUNG & THOMPSON, 209 Madison Street, Suite 500, Alexandria, VA, 22314, US

(73) Assignee: SCA HYGIENE PRODUCTS GMBH, MANNHEIM (DE)

(21) Appl. No.: 12/442,866

(22) PCT Filed: Nov. 27, 2006
(86) PCT No.: PCT/EP06/11365

§ 371 Date: May 13, 2009

(51) Int. Cl. B32B 7/14; B29C 65/80

(52) U.S. Cl. 428/120; 156/446

(57) ABSTRACT

A device for gluing a tail cant of a roll or log of wound web material, includes a support for the roll, a dispenser of glue, a movable blade on which a gluing application edge is provided, the blade (5) being oriented parallel to the roll-longitudinal axis (CD). The glue application edge (10) of the blade (5) has interrupted glue application surface.

### TECHNICAL FIELD

In paper products wound to a roll or reel or log using tissue-paper or non-woven material, being products as toilet papers or kitchen towels the trailing end or trailing cant of the roll or log is glued to an underlying web of the roll or log. “Log” is a material web wound to a reel in a rewinder, said log finally being cut into a plurality of part-lengths for final roll as toilet paper roll or kitchen towel roll. For using the first sheets of the roll the first sheet glued to an underlying sheet has to be torn off.

### BACKGROUND ART

From US 2005/0199761 A1 and US 2005/0199759 A1 it is known to control the strength and location of bonds by controlling the penetration of adhesive into the tissue. This stands in connection with easy starting rolls of perforated tissue product which have a reduced tendency to ply separate. Such rolls are formed with an adhesively secured doubled over tail tap folded against the roll.

A method or an apparatus for securing the tail or outer terminal convolution of a toilet tissue cant or similar roll product to the convolution immediately adjacent the tail is known from U.S. Pat. No. 4,026,752. The tail of the roll product is secured by means of adhesive, and the method includes the step of ejecting a predetermined quantity of adhesive directly onto the subjacent convolution of the roll product while the tail is unwound there from. The adhesive is distributed along the length of the cant at spaced apart locations adapted to underlie the rewound tail, thereby allowing the tail to be adhesively secured to the cant. Each adhesive applicator module includes a plurality of dispensing nozzles operative to eject a measured quantity of adhesive onto a cant underlying the same.

WO 95/15902 describes a device for gluing the tail end of a reel of wound web material comprising a dispenser of glue for applying the glue to the reel and means for rewinding the tail end after the glue has been applied. Applied to the tail end is the glue by a transverse bar as a continuous glue strip and upwardly the bar is provided with a concave surface which is in practice a longitudinal channel extending substantially along the whole length of the bar.

### DISCLOSURE OF THE INVENTION

It is the problem (object) to be solved to reengineer the tail sealing process so that a soft tear off of paper could be secured without disruptions of first and following plies, combined with improved optical appearance.

This problem is solved by a device for gluing a tail cant or tail sheet of a roll or log of wound web material, inter alia, comprising a support for the roll or log, a dispenser of glue, at least one movable blade on which a glue-application-edge is provided, said blade being oriented parallel to the roll or log longitudinal axis (cross machine direction—CD). The glue application edge of the blade has an interrupted glue application surface.

The device according to the invention may comprise at least one movable blade. Although using one movable blade is preferred, it is also possible that such a device may comprise two, three or even more of these movable blades.

By this solution it is possible for the consumer to avoid struggling with too sticky tail sealing. Furthermore, it is avoided that more than one sheet is torn off and it is avoided to disrupt the ply lamination. This is achieved with low costs and pleasant optical appearance. In contrast to the prior art not a continuous glue strip is applied but a glue strip with interruptions accordingly the product rolls are to be handled in a better manner and with better comfort.

Tail sealing of such paper product rolls or logs is necessary especially for keeping the form of the roll in handling (conveying) of the rolls during manufacture and for packaging the rolls. Thereafter tail sealing would not be necessary. During conveying forces are applied to the roll and the tail sheet in cross machine direction CD, i.e. parallel to the longitudinal axis of the roll. According to the teaching of the present invention sufficient tail sealing force against tearing off is achieved allowing simultaneously a simple and easy tearing off in machine direction MD, i.e. perpendicular to the longitudinal axis of the roll when separating the tail sheet of the roll without destroying underlying sheets.

Furthermore, the glue application edge of the blade is a lengthwise discontinuous edge and preferably the glue application edge of the blade provides in longitudinal direction merlons and crenels, said merlons forming the glue application surface.

There exist two possibilities for orientation of portions of the glue application surfaces. According to one possibility the portions of the glue application surfaces are lengthwise or spotlike oriented in CD of the roll or log i.e. parallel to the longitudinal axis of the roll. In the CD-orientation of the portions an excellent gluing effect keeps the sheet with safety on the roll or log when the roll or log is conveyed in CD direction and a relative movement between the roll or log and the conveying means creates a force applied to the tail sheet. Due to the row of portions of the glue application surface a smaller tear off force is necessary for separating the tail sheet from the roll so that both requirements being normally in contradiction are fulfilled.

As a second possibility portions of the glue application surface are lengthwise oriented in a direction perpendicular to the roll or log longitudinal axis (machine direction MD). Also with this possibility the two requirements are fulfilled in an optimised manner because in a row the larger length of the portions of the glue application surface (orientation in MD) also contributes to a higher gluing effect in CD and a more easy tearing off in MD is possibly without destroying the underlying sheet, because tearing off starts with a lower amount of glued areas because the glue portions on the tail sheet are extending in MD.

An essential point is the choice for the amount of glue application surface being for instance between 25% and 90% of the surface glue application edge of the blade, preferably between 30% and 70% and most preferably between 50% and 60%.

According to a further possibility the glue application surface of the blade is formed by portions of the blade being oriented lengthwise substantially perpendicular to the longitudinal extension of the blade and extend beyond the widths of the blade. By such a blade portions of the glue application surface are lengthwise oriented in a direction perpendicular to the roll or log longitudinal axis (MD).

On the one hand, the portions forming the glue application surface are integral parts of the blade or, on the other hand, the portions forming the glue application surface are parts fastened in a distanced manner to the blade.

By such a solution it is possible to keep the widths of the blade itself small and thin.

Furthermore, the problem is solved by a product roll of tissue-paper or non-woven material comprising a web formed of paper sheets connected one to another by weakened lines and wound to the product roll, a tail sheet being glued to underlying sheet or sheets. A glue pattern is present in form of a row of separated glue portions. Preferably the ratio between length and width of the respective glue portions is at least 2:1, especially at least 3:1.

Preferably, the longitudinal extension of the glue portions is parallel to the longitudinal axis of the roll or the longitudinal extension of the glue portions is perpendicular to the longitudinal axis of the roll.

### BRIEF DESCRIPTION OF THE DRAWINGS

FIG. 1 is a diagrammatic perspective view of a device for tail sealing of a roll by applying glue.

FIGS. 2a,b is a diagrammatic view of a blade having a discontinuous glue application edge.

FIG. 3a shows a roll with portions of a glue pattern oriented in MD.

FIG. 3b shows portions of a glue pattern being oriented in CD.

FIGS. 4a to 4f show another embodiment of a tail sealing device illustrating stepwise the tail sealing process.

FIGS. 5 to 12 show different embodiments of the blade.

### EMBODIMENTS OF THE INVENTION

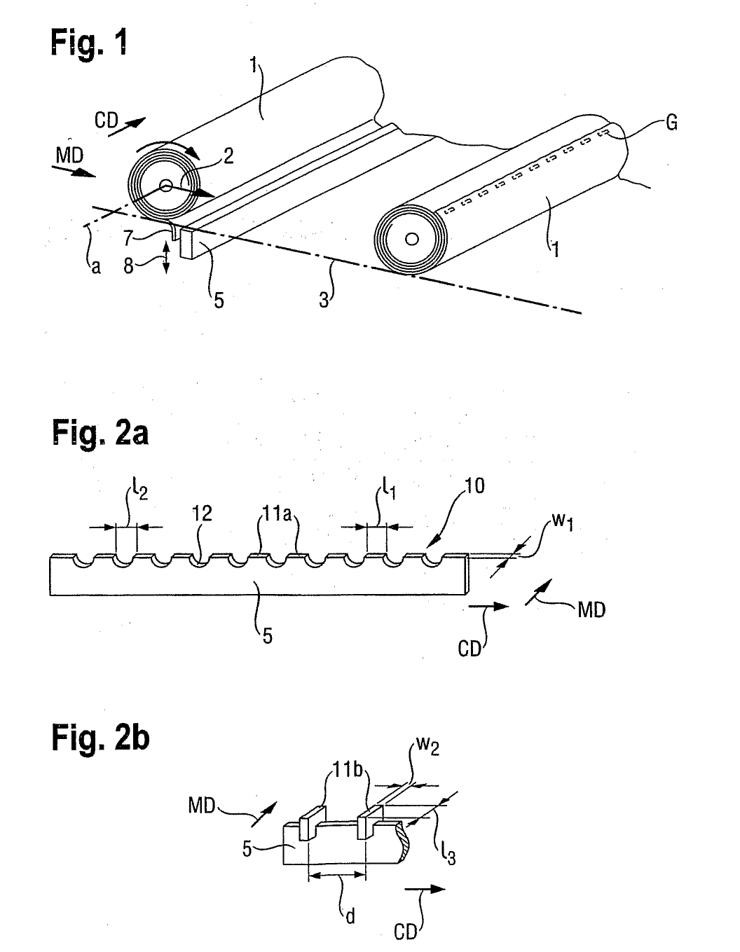

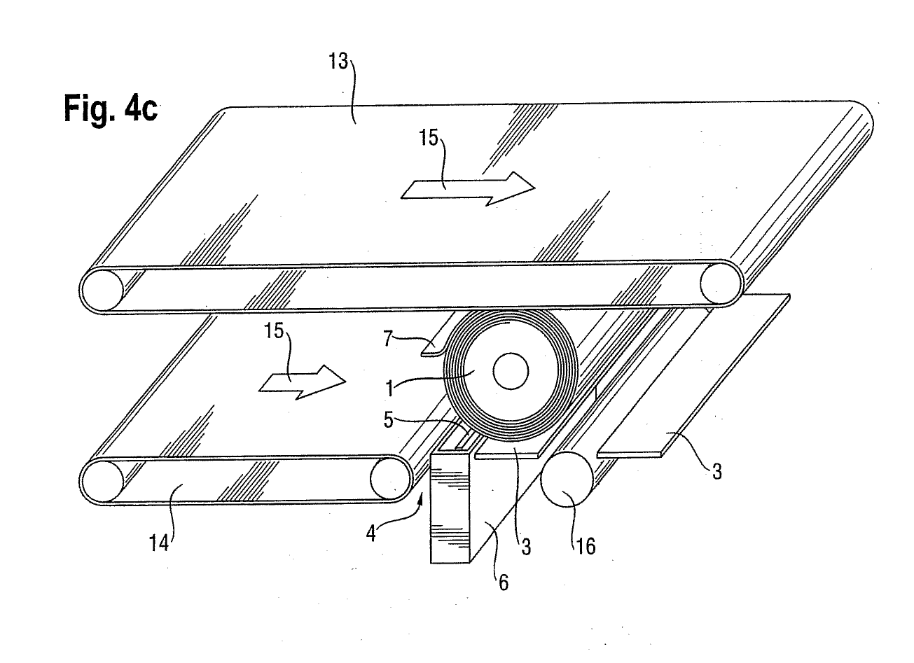

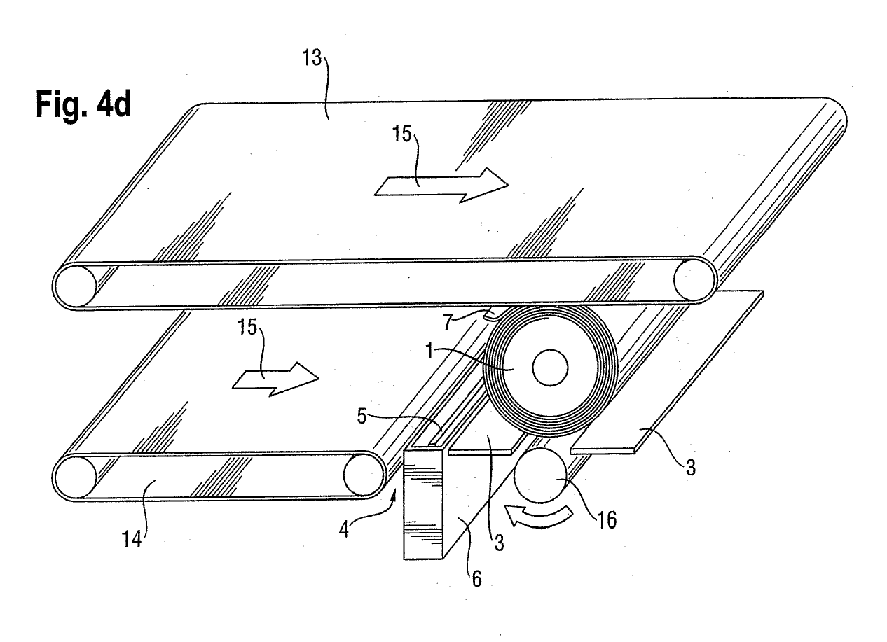

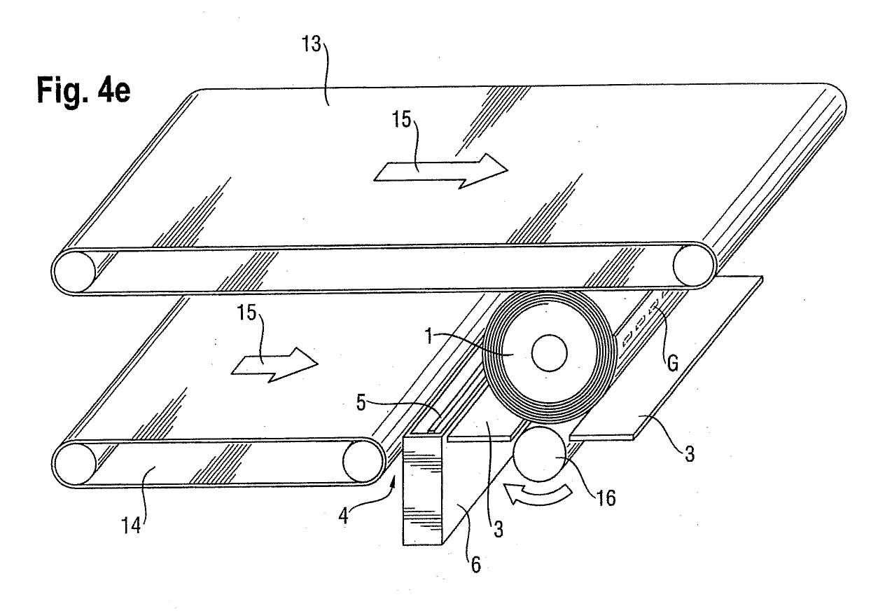

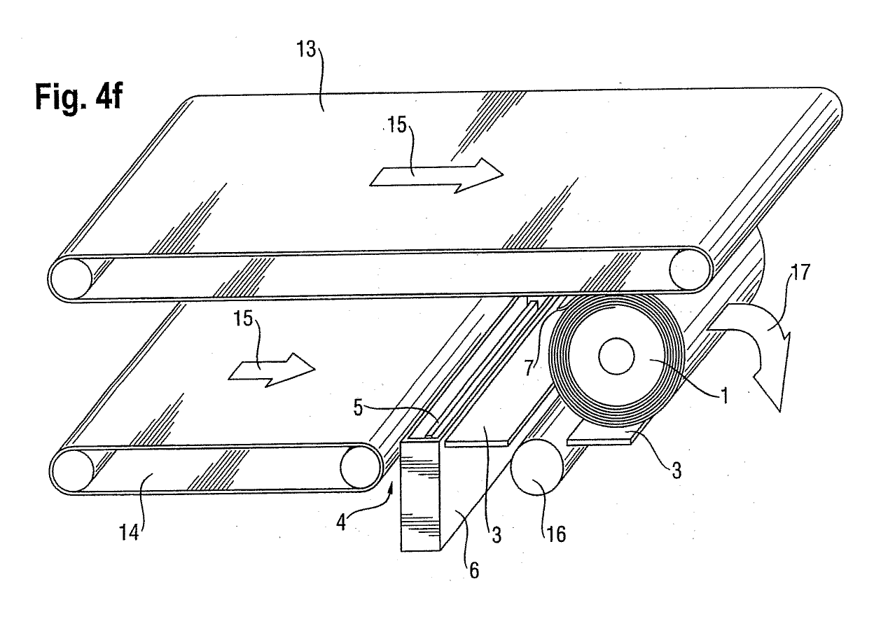

FIG. 1 illustrates in a diagrammatic manner a roll or log 1 conveyed in direction of the arrow 2 on a conveying surface 3. Beneath a glue application slot 4 (not illustrated in FIG. 4) a blade 5 and glue chamber 6 (not illustrated here) are provided for application glue on the tail sheet 7 on the roll 1. The blade 5 is movable forward and backwards according to an arrow 8.

When a log from which shorter lengths of rolls are cut is leaving the rewinder head it rolls down a slope where a blade is placed in CD. The glue application surface of the blade carriers aforementioned glue and transfers it to the end of the roll (tail sheet) whilst continuing the revolution of the log down the slope, the glue carrying paper is wrapped further around the log and a tail sheet is attached to the log. Alternatively, spray application, moving spray head in CD or any continuous means like a wire in CD can provide the same result.

The longitudinal axis of the roll 1 is marked in FIG. 1 as having the reference letter a.

The glue application blade illustrated diagrammatically in FIG. 2a has a glue application edge 10 having a glue application surface formed in its entirety by surface portions 11a being crenels interrupted by merlons 12. The portions 11a are lengthwise oriented in CD and have a length l₁ and the merlons 12 have a length l₂. The blade itself has a width w₁.

FIG. 2b shows an alternative or embodiment of the blade 5. There are glue application portions 11b. These are oriented in MD. These portions have a length l₃ and are in CD in a distance of d and a width w₂.

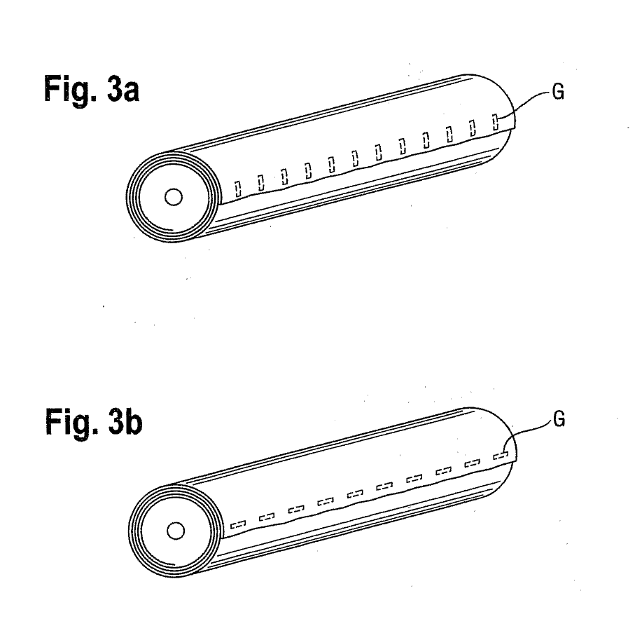

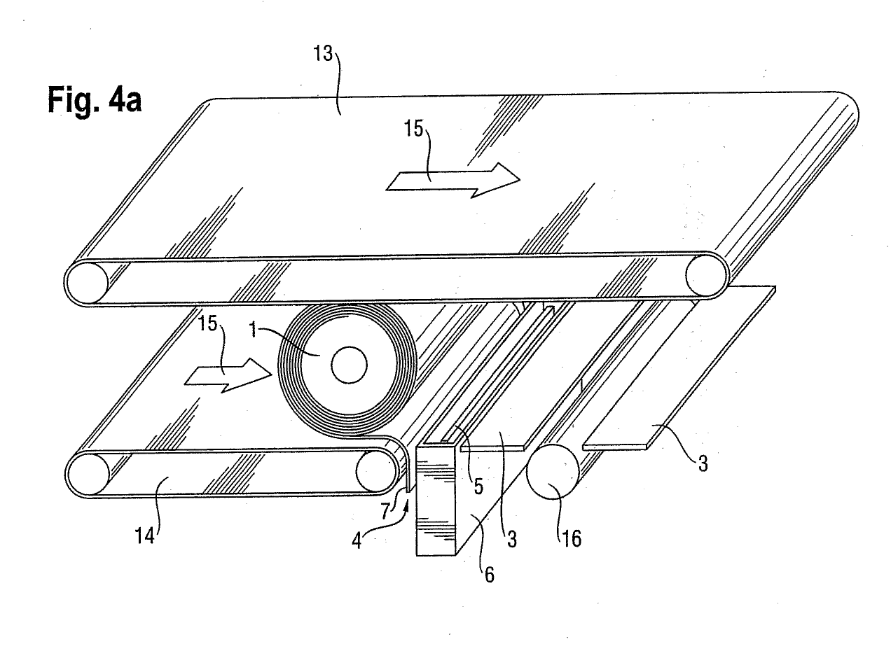

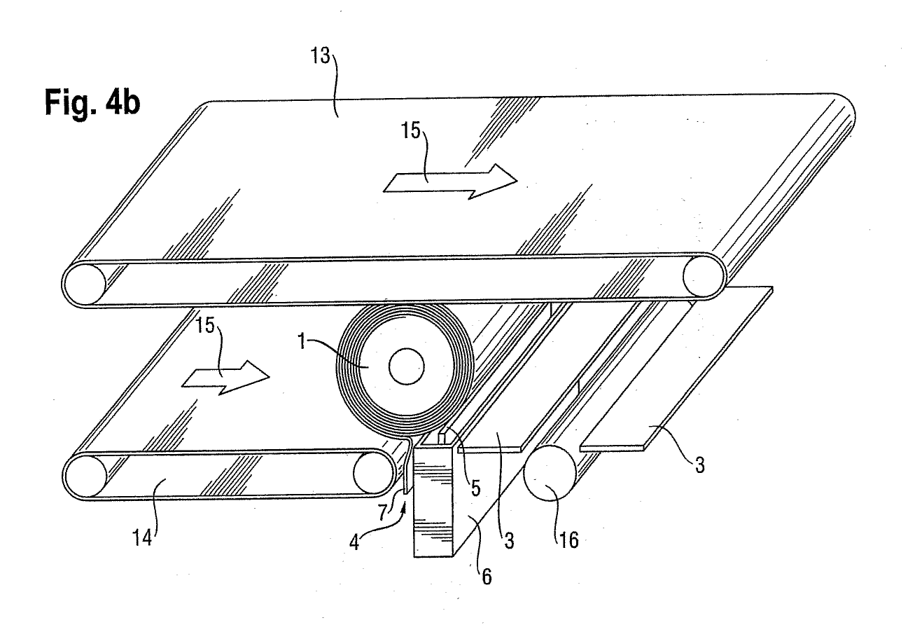

According to the blade illustrated in FIG. 2a the portions 11a of the glue application surface is oriented in CD and the portions 11b according to FIG. 2b are oriented in MD, which leads to a glue application pattern result illustrated in FIG. 3a and FIG. 3b.

In FIGS. 4a to 4f another mode of glue application and tail sealing is illustrated step by step from FIG. 4a to FIG. 4f. This device shows an upper conveyer belt 13 as an endless belt and a lower conveyer belt 14 as an endless belt. Between these conveyer belts a roll 1 is conveyed in the direction of the arrow 15, since the conveyer belts are driven in the same direction. The tail or tail sheet 7 is sucked into the gap 4 and the blade 5 is retracted within the glue chamber 6. Downstream of the gap 4 a stationary support 3 is illustrated, wherein a pressure roller 16 is provided. This condition is illustrated in FIG. 4a. In the next step according to FIG. 4b the blade 5 is extended in an upper position and glue is applied here not to the tail sheet but on the circumference of the roll 1 where the tail sheet ends. Thereafter, the blade 5 is retracted and the roll 1 is furthermore transferred to the right side on the support 3. This is illustrated in FIG. 4c. In FIG. 4d a position is illustrated where the roll 1 is provided between the upper conveyer belt 13 and the pressure roller 16, which is then rotated such that the roll 1 is rotated between the conveyer belt 13 and the pressure roller 16. This is illustrated in FIGS. 4d and 4e. In FIG. 4e is visible the tail sheet already fastened by gluing and by the pressure roller the bonding effect is increased. Then the rotation of the pressure roller is stopped and the roll 1 is delivered in the direction of the arrow 17. In FIG. 4e the applied glue pattern is marked by the reference number G.

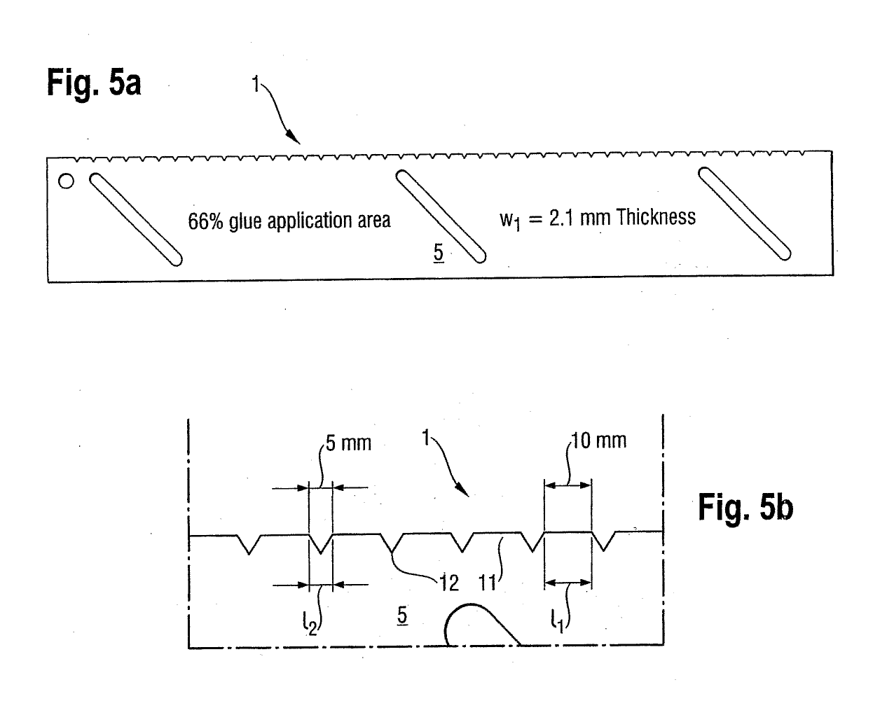

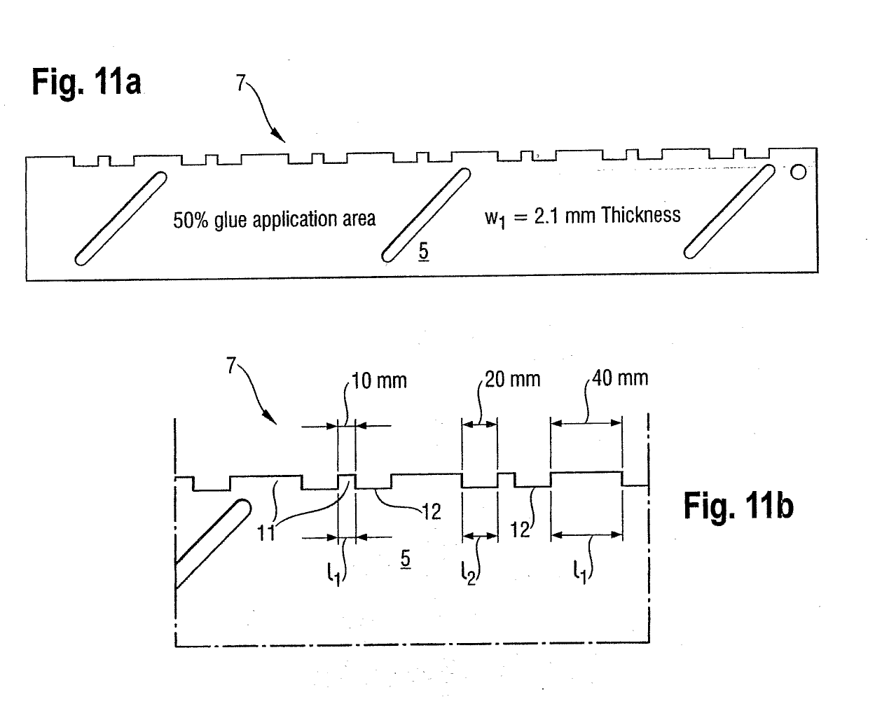

Tests were made with some of several tail seal blades 1 to 8 according to FIG. 5a to FIG. 12b (8 different blades), whereby blades 1, 2, 4, 5 and 7 are blades according to the invention and blades 3, 6 and 8 are blades according to the prior art shown for comparative reasons.

FIG. 5a shows the whole blade and FIG. 5b an enlarged part of the blade 1 with the contour of the glue application edge. The thickness w1 of the blade is 2.1 mm the merlon 11 has a length l₁ of 10 mm and the crenel 12 a length l₂ of 5 mm. The glue application area, which means the sum of all portions of the glue application surface, is 66% of the whole glue application edge when the glue application edge is not interrupted or discontinuous.

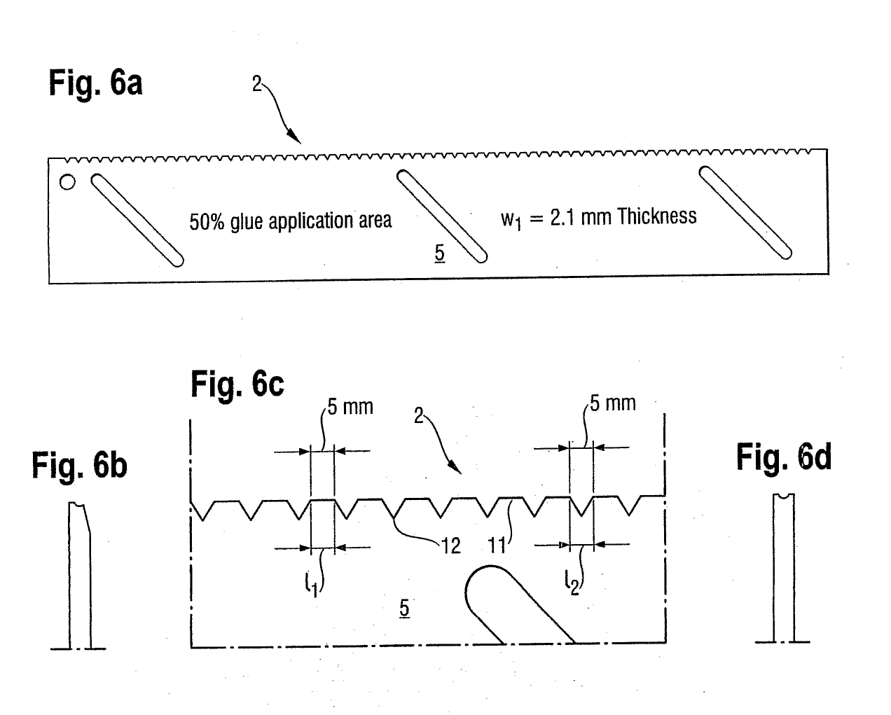

Tail seal blade 2 is illustrated in FIGS. 6a, 6b, 6c and 6d. The FIGS. 6b and 6d show the glue application surface having a groove so that the glue application surface is reduced. This is a possibility being not considered in connection with the tests. The glue application area here is 50% and the thickness w₁ is also 2.1 mm. The length l₁ is the same as the length l₂ being 5 mm.

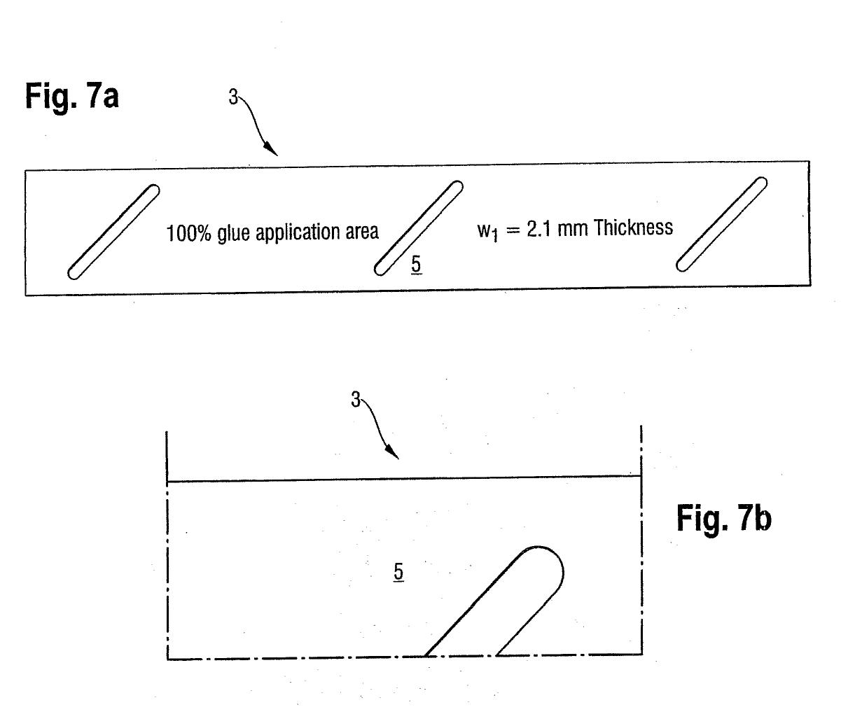

Tail seal blade 3 is illustrated in FIG. 7a and FIG. 7b. Here the glue application area is 100% and the thickness w₁ 2.1 mm. This blade is used for comparison only, because this complies with the prior art.

By the blades 1 and 2 a glue pattern according to FIG. 3b is achieved.

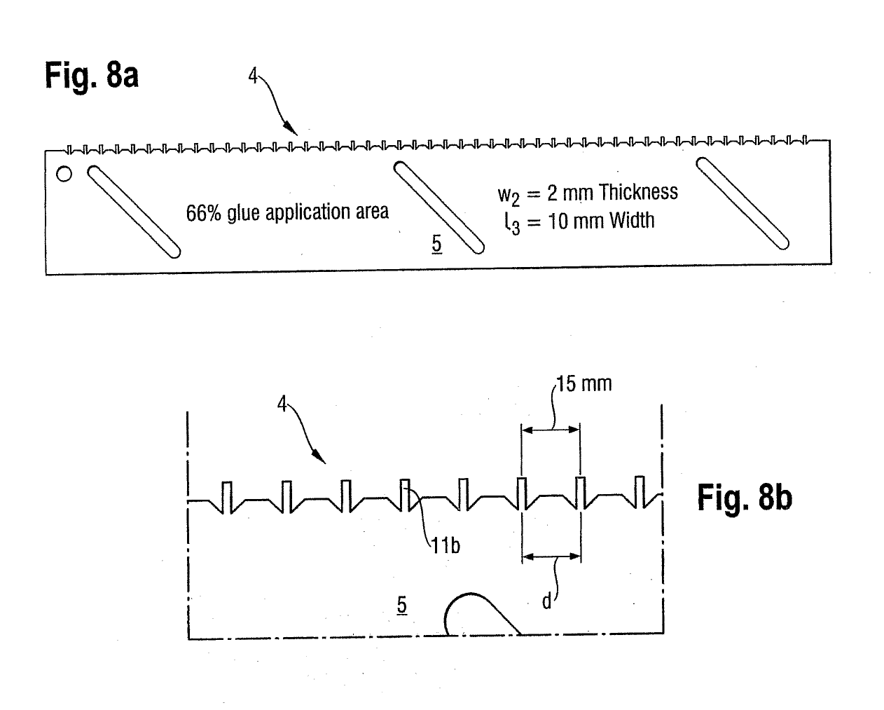

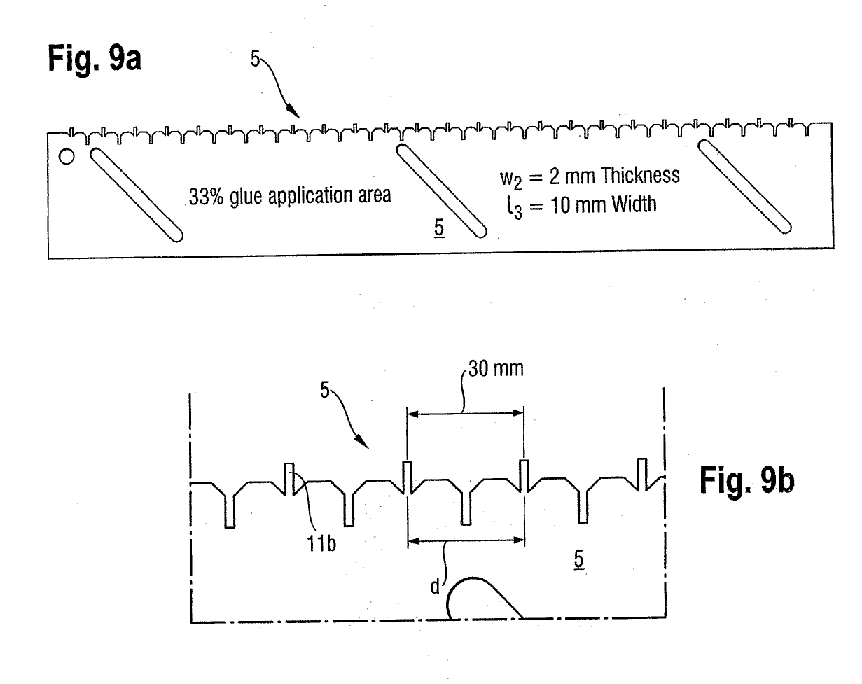

Tail seal blade 4 as illustrated in FIGS. 8a and 8b uses inserts 11b as illustrated in FIG. 2b. The same is for tail seal blade 5 illustrated in FIGS. 9a and 9b. The glue application area is 66%. The thickness w₂ is 2 mm and the width l₃ 10 mm. The distance between the inserts 11b(d) is 15 mm.

Tail seal blade 5 according to FIGS. 9a and 9b has a glue application area of 33%. The thickness w₂ is 2 mm and the widths l₃ is 10 mm. The distance d between the inserts 11b is 30 mm.

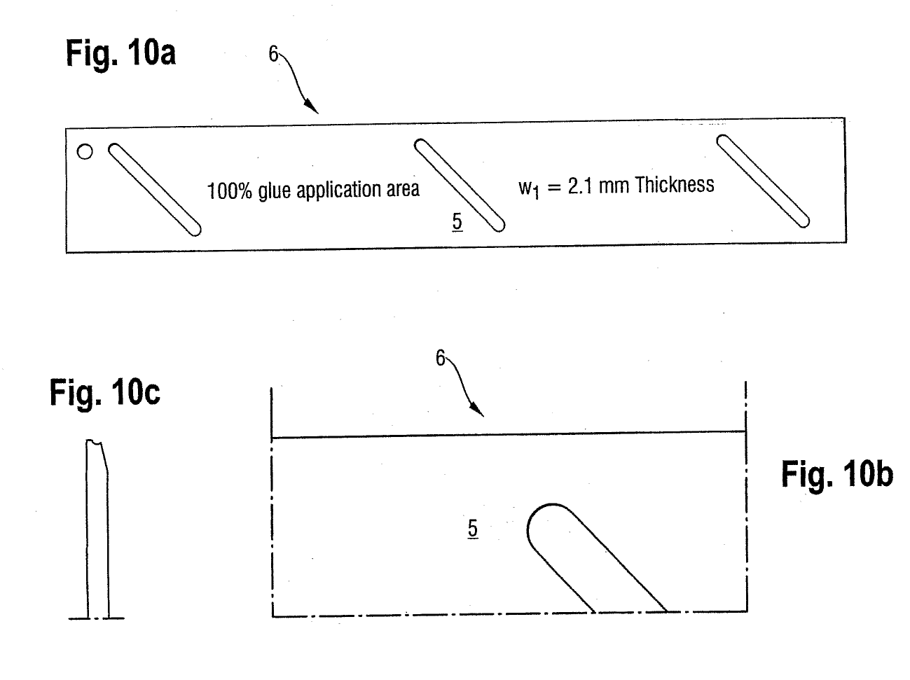

Again tail seal blade 6 according to FIGS. 10a and 10b shows a blade 5 according to the prior art without discontinuous glue application surface. Therefore, the glue application area is 100% and the thickness w₁ is 2.1 mm.

Tail seal blade 7 shows another crenellated configuration of the glue application edge, where the crenels 12 have the same lengths l₂ of 20 mm. The lengths l₁ of the merlons 11 is different being 10 mm and 40 mm. Correspondingly, the glue application area is 50% and the thickness of the blade is 2.1 mm.

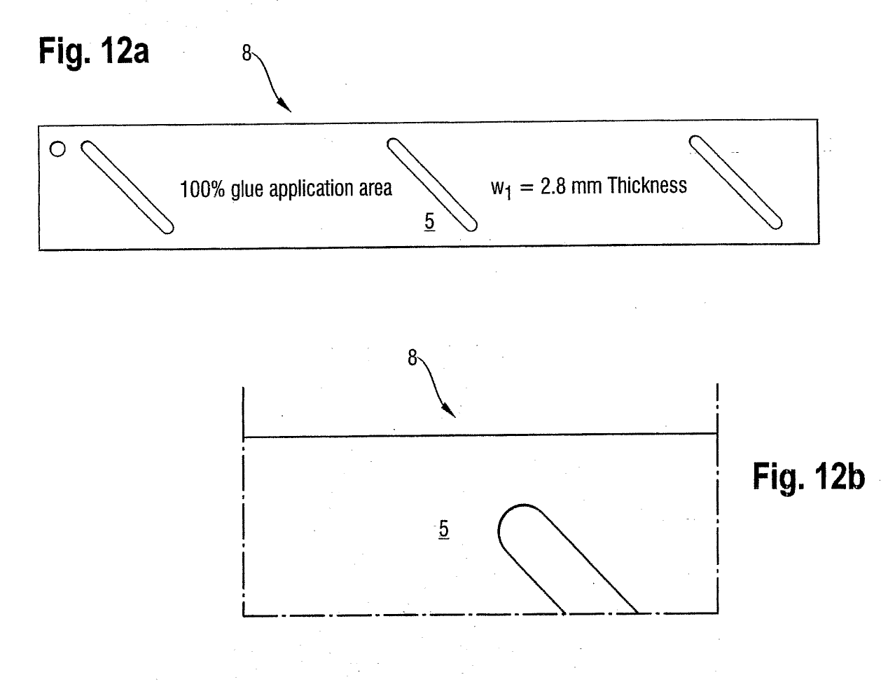

Finally, tail seal blade 8 shows a blade according to the prior art without discontinuous glue application edge. Therefore, the glue application area is 100% but the thickness w 1 now is 2.8 mm. This seal blade 8 is illustrated in FIGS. 12a and 12b.

The blades were tested with different glues according to the following table 1.

| Variant | Blade | Glue | Solid Content | Color |
|---|---|---|---|---|
| 1 | 8 | STC 0190 (Henkel) | ? | — |
| 2 | 4 | TS 0190 (Henkel) | 6 | — |
| 3 | 5 | TS 0190 (Henkel) | 6 | — |
| 4 | 7 | TS 0190 (Henkel) | 6 | — |

The test results are listed in table 2 as an evaluation matrix.

| | A) Tear off | B) Tear off | C) Penetration | D) Optical | E) Adhesion | F) Penetration | G) Optical |
|---|---|---|---|---|---|---|---|
| | behaviour | behaviour | behaviour through | appearance | to ply | behaviour to ply | appearance |
| Variant | MD | CD | top ply TS | TS | underneath | underneath AP | AP |
| 1 | 5 | 1 | 4 | 4 | 5 | 5 | 4 |
| 2 | 1.5 | 2 | 3 | 1 | 1.5 | 1.5 | 1 |
| 3 | 1 | 2.5 | 3 | 1 | 1 | 1 | 1 |
| 4 | 1.5 | 2 | 3 | 1.5 | 1 | 1 | 1 |

Tables 1 and 2 illustrate the variants 1 to 4.

As follows, the basis for evaluation and weighting is as follows:

Adhesion at Tail Seal Point
A) Tear off behaviour MD:
   1=soft/5=strong
B) Tear off behaviour CD:
   1=strong/5=soft
C) Penetration behaviour through top ply:
   1=low/5=high
D) Optical appearance:
   1=good/5=bad

### Adhesion at Application Point

E) Adhesion to ply underneath:
   1=soft/5=strong
F) Penetration behaviour to ply underneath:
   1=low/5=high
G) Optical appearance:
   1=good/5=bad

Table 2 demonstrates that those variants 2, 3 and 4 according to the invention (using blades 4, 5 and 7) result in an improved product performance in terms of optical appearance, adhesion and penetration compared with variant 1 according to the prior art (using blade 8). In addition product-rolls obtained from variants 2, 3 and 4 are characterized by an improved tear-off strength in CD than in MD compared to product-rolls according to the prior art (variant 1) thereby leading to a very convenient product for the consumer in view of tearing off the first sheet.

Table 3 shows the weighting factor with respect to the consumers and the production.

| | Consumer | Production |
|---|---|---|
| Tear off MD TS | 25% | 75% |
| Tear off CD TS | 75% | 25% |
| Penetration TS | 25% | 75% |
| Optical App. TS | 25% | 75% |
| Adhesion AP | 75% | 25% |
| Penetration AP | 75% | 25% |
| Optical App. Ap | 75% | 25% |

1-17. (canceled)

18. Device for gluing a tail cant or tail sheet of a roll or log of wound web material, comprising a support for the roll or log, a dispenser of glue, at least one movable blade on which a gluing application edge is provided, said blade being oriented parallel to the roll or log longitudinal axis, wherein the glue application edge of the blade has an interrupted glue application surface.

19. The device according to claim 18, wherein the glue application edge of the blade is a lengthwise discontinuous edge.

20. The device according to claim 19, wherein the glue application edge of the blade provides in longitudinal direction merlons and crenels, said merlons forming the glue application surface.

21. The device according to claim 18, wherein portions of the glue application surface are spots oriented in a cross machine direction of the roll or log.

22. The device according to claim 18, wherein portions of the glue application surface are lengthwise oriented in a cross machine direction of the roll or log.

23. The device according to claim 18, wherein portions of the glue application surface are lengthwise oriented in a direction perpendicular to the roll or log longitudinal axis.

24. The device according to claim 18, wherein the glue application surface is between 25% and 90% of the glue application edge of the blade.

25. The device according to claim 24, wherein the glue application surface is between 30% and 70% of the glue application edge of the blade.

26. The device according to claim 24, wherein the glue application surface is between 50% and 60% of the glue application edge of the blade.

27. The device according to claim 23, wherein the glue application surface of the blade is formed by parts being oriented lengthwise substantially perpendicularly to the longitudinal extension of the blade and extend beyond the widths (w 1) of the blade.

28. The device according to claim 27, wherein the parts are integral with the blade.

29. The device according to claim 27, wherein the parts are fastened to the blade in a distanced manner.

30. Product-roll of tissue-paper or non-woven material, comprising a web formed of paper sheets connected one to another in a row by weakened lines and wound to the product roll, a tail sheet being glued to underlying sheet or sheets, wherein a glue pattern is present in the form of a row of separated glue portions.

31. The product-roll according to claim 30, wherein the longitudinal extension of the glue portions is parallel to the longitudinal axis of the roll.

32. The product-roll according to claim 30, wherein the longitudinal extension of the glue portions is perpendicular to the longitudinal axis of the roll.

33. The product-roll according to claim 30, wherein the ratio between length and width of the respective glue portions is at least 2:1.

34. The product-roll according to claim 33, wherein the ratio between length and width of the respective glue portion is at least 3:1.
